(19) United States
(12) Patent Application Publication
(10) Pub. No.: US 2009/0122017 A1
(43) Pub. Date: May 14, 2009

(54) MOBILE ELECTRONIC DEVICE HAVING CAPACITIVE SENSOR WITH REDUCED VISIBILITY ISOLATION AREAS AND CORRESPONDING METHOD

(75) Inventors: David Michael Emig, Trenton, IL (US); Zhiming Zhuang, Kildeer, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/937,723

(22) Filed: Nov. 9, 2007

(51) Int. Cl. G06F 3/041

(52) U.S. Cl. 345/173

(57) ABSTRACT

A mobile electronic device and corresponding method have a user interface for receiving a touch input. The mobile electronic device includes a capacitive sensor having an electrode layer with non-etched away portions and etched away portions, and having isolation areas formed in the etched away portions, and a segmented optical shutter disposed on a side of the capacitive sensor, the optical shutter including a liquid crystal layer sandwiched between a top absorbing polarizer and a bottom absorbing polarizer, and including a reflectance increasing element disposed between the liquid crystal layer and the bottom absorbing polarizer. A reflectance of the reflectance increasing element is selected to reduce a ratio of a reflectance through the non-etched away portions to a reflectance through the etched away portions to make an appearance of the user interface substantially uniform in an off state.

### BACKGROUND OF THE INVENTION

1. Field of the Invention

The invention relates generally to a mobile electronic device having a capacitive sensor with reduced visibility isolation areas.

2. Introduction

Mobile electronic devices, such as cellular phones, handheld computers, MP3 players, laptop computers, and the like are very pervasive computing devices. The electronic devices provide various features, such as communications, computing features, Internet access, playing music or video, viewing images, etc. Such electronic devices will often include a display, such as an LCD liquid crystal display).

One issue associated with the integration of new features and functionality with devices like mobile telephones involves the user interface. Traditional mobile telephones only included 12 to 15 keys. Such devices are sometimes not compatible with new features and functions as new modes of operation require new, dedicated keys or input devices in addition to the basic phone keys. Further, the devices may also require additional keys for the purpose of navigation or initiation of the modes within the device.

One solution to the need for more keys in the user interface is to simply add more buttons to the device. Some devices, for example, include full keypads with forty to fifty keys. The problem with this solution is that many mobile devices, including mobile telephones, are getting smaller and thinner. When many keys are clustered in one location, the likelihood of user confusion or difficulty with operation of the device increases. What's more, in a particular mode, many of the keys are not needed. For example, when a device is in a camera mode, the number keys 1-9 are generally not needed to take pictures.

Commonly assigned, co-pending U.S. patent application Ser. No. 11/684,454, filed Mar. 9, 2007, entitled “Multimodal Adaptive User Interface for a Portable Electronic Device,” and Ser. No. 11/679,228, filed Feb. 27, 2007, entitled “Adaptable User Interface and Mechanism for a Portable Electronic Device”, incorporated herein by reference in their entirety, each teach a method and apparatus for providing a portable electronic device that hides and reveals various keypad configurations to a user by way of an optical shutter. The optical shutter is configured to selectively open and close shutter segments by the application of an electric field, thereby hiding and revealing user actuation targets. Formed above the optical shutter is a capacitive sensor configured to detect the presence of an object, such as a user's finger, near to or touching any particular user interface actuation target in the user interface area seen by a user through the clear plastic cover of the device.

The capacitive sensor may include an Indium Tin Oxide (ITO) layer selectively etched to produce regions of ITO which are electrically isolated from one another. The regions where the ITO has been etched away are known as “isolation areas”. One issue with such a device is that the ITO regions reflect a significantly larger amount of light than the isolation areas. When the device is in an off state, it may be intended to produce a uniform black or grey appearance. For example, the ITO layer may be laminated to a black or grey background to produce a black or grey appearance. While most of the light transmitted through the capacitive sensor may be absorbed by the black background, additional light which is reflected off of the ITO regions may be highly visible in contrast to the black background, which is seen through the isolation areas, making the ITO pattern visible. It has been found that the ITO regions may typically have a four times greater reflectance than the isolation areas.

### SUMMARY OF THE INVENTION

A mobile electronic device and corresponding method have a user interface for receiving a touch input. The mobile electronic device includes a capacitive sensor having an electrode layer with non-etched away portions and etched away portions, and having isolation areas formed in the etched away portions, and a segmented optical shutter disposed on a side of the capacitive sensor, the optical shutter including a liquid crystal layer sandwiched between a top absorbing polarizer and a bottom absorbing polarizer, and including a reflectance increasing element disposed between the liquid crystal layer and the bottom absorbing polarizer. A reflectance of the reflectance increasing element is selected to reduce a ratio of a reflectance through the non-etched away portions to a reflectance through the etched away portions to make an appearance of the user interface substantially uniform in an off state.

### BRIEF DESCRIPTION OF THE DRAWINGS

In order to describe the manner in which advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of a mobile electronic device in accordance with a possible embodiment of the invention;

FIG. 2 illustrates a diagram of an exemplary mobile electronic device in accordance with a possible embodiment of the invention;

FIG. 3 illustrates an exemplary block diagram of an exemplary mobile electronic device in accordance with a possible embodiment of the invention; and

FIG. 4 is an exemplary flowchart illustrating a method of manufacturing according to embodiments of the invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without departing from the spirit and scope of the invention.

The invention comprises a variety of embodiments, such as a method and apparatus and other embodiments that relate to the basic concepts of the invention. The invention may include a morphing keypad that performs a hiding and revealing function by opening and closing shutters in an optical shutter element. The optical shutter element acts as a segmented electro-optical device in that it selectively alters an axis of polarization of light passing through the keypad. When the electro-optical device is used in conjunction with light polarization layers, the alteration of the axis of polarization causes predetermined shutters to open or close, altering the appearance visible to a user.

The light polarization layers absorb light polarized along an axis of polarization and transmit light polarized along a second axis of polarization. While some small amount of light polarized along a first axis may be reflected, the majority of light is absorbed by the polarizer. These polarizers are therefore generally grey or black in appearance when absorbing light. Thus, when the optical shutters are all closed, the face of the device may have a grey or black appearance, and it would be beneficial if this appearance was uniform. The present invention provides a substantially uniform appearance to the face of the mobile electronic device s further described below.

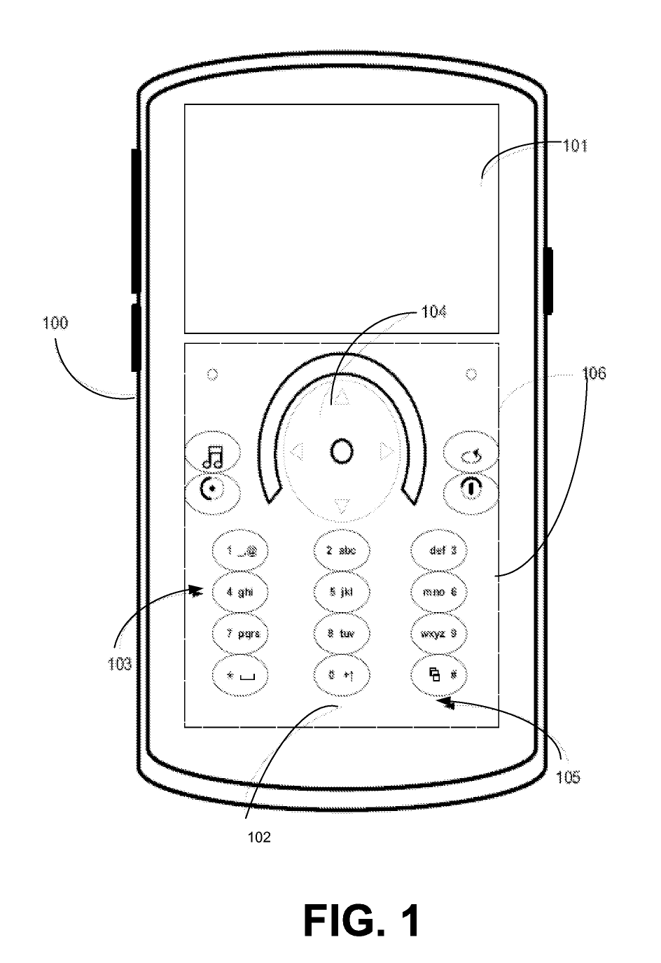

FIG. 1 illustrates an exemplary diagram of a mobile electronic device 100 in accordance with a possible embodiment of the invention. The mobile electronic device may include a high resolution display 101 and a segmented electro-optical display 102. The segmented electro-optical display 102 is configured as an optical shutter to present a mode-based dynamic keypad 103 to a user. The mode-based dynamic keypad 103 may display one of a plurality of keypad configurations, and is associated with the current mode of operation of the electronic device 100. The mode-based dynamic keypad 103, and its keypad configuration, may include only those keys necessary for navigating the particular operating mode of the device.

In addition to the high-resolution display 101 and the segmented electro-optical display 102, the exemplary electronic device 100 shown in FIG. 1 also may include a navigation device 104. The navigation device 104 may be used for selectively navigating between the various modes of the device. The navigation device 104 may also be used as a control for each operational mode. The navigation device 104 may be continually accessible to the user. Alternatively, the navigation device may be selectively hidden and revealed by the segmented electro-optical display 102. The navigation device 104 is disposed, in the embodiment of FIG. 1, in the keypad region 106 of the electronic device 100. This geometric location allows the navigation device 104 to be large and easily accessible.

The high-resolution display 101 may comprise a liquid crystal display (LCD) configured to present device information to the user. The term “high-resolution display 101” is used herein to refer to a device that can present text and images to a user by altering a large number of pixels which, when viewed collectively by a user, form the presented text or image. The term “high-resolution” is used herein to mean a display suitable for the presentation of text, information, and graphics on a mobile device with sufficient granularity as to be easily switched between graphics or text. For example, the high-resolution display would be one suitable for presenting an image in the Joint Photographics Expert Group (JPEG) format to the user. Such displays generally are configured to turn on and off individual pixels by way of a display driver for the presentation of high-resolution information. Examples include a 256-pixel by 128-pixel reflective or backlit LCD, although any size LCD may be used.

The front surface 105 of the electronic device 100 forms the overall user interface. In the keypad region 106, the segmented electro-optical display 102 provides a dynamic user input interface. This dynamic user interface is configured to present different indicators, which may appear as actuation targets, across the user interface in keypad region 106, for example.

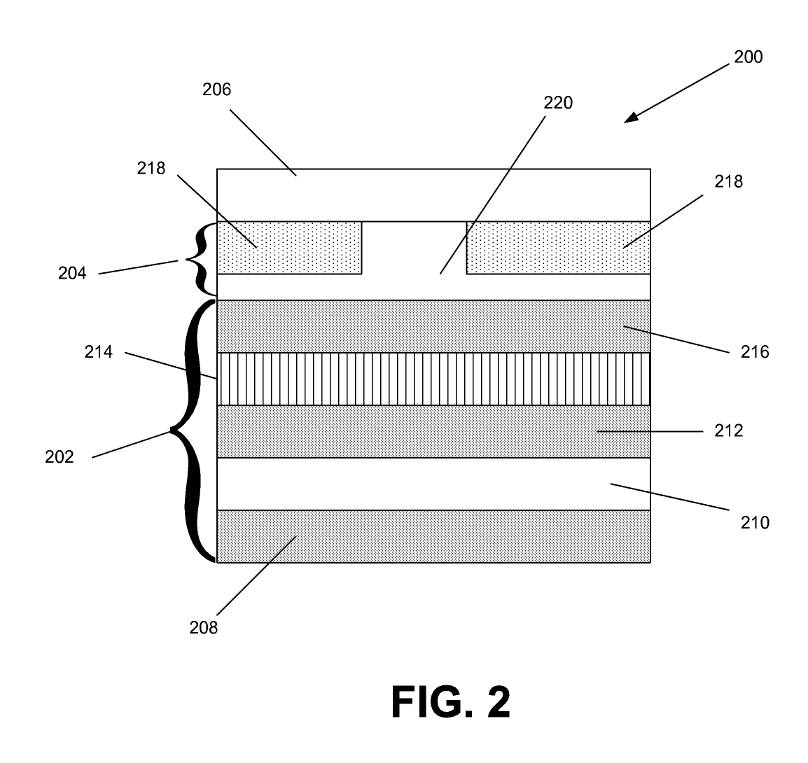

FIG. 2 illustrates a side view of a dynamic user interface 200 that may form an exemplary electronic device 100 in accordance with embodiments of the invention. The user interface 200 may include several layers. While several layers are shown, each and every layer may not be necessary for every application, and the structure shown is exemplary. Additionally, extra layers not shown could also be included as needed, such as substrate or electrode layers.

The user interface 200 includes a segmented optical shutter 202, a capacitive sensor 204, and a cover layer 206. The optical shutter 202 includes bottom polarizer 208, DBEF layer 210, low-E polarizer 212, liquid crystal material 214, and top polarizer 216. The bottom polarizer 208 and the top polarizer 216 may be absorbing polarizers. The optical shutter may also include a patterned electrode (not shown) showing the keys or symbols, and application of an electric field can selectively cause transmission properties of the liquid crystal material to be altered, thus causing selective opening and closing of the optical shutter windows to reveal keys as desired. For example, a music player mode may correspond to a first configuration, and a phone mode may correspond to an alternate configuration. The liquid crystal material 214 may be a twisted nematic liquid crystal (TNLC) material, although other types of liquid crystal material may be used. The cover layer 206 may be a thin plastic film, glass, or other suitable material.

The capacitive sensor 204 is configured to detect the presence of an object, such as the user's finger, near to or touching the user interface 200. A change in capacitance near a touched region is detected, and in this way a user's selection of actuation targets, such as a key on a keypad, may be detected. The capacitive sensor may be formed from an electrode layer 218 and an adhesive layer 220. The electrode layer 218 may be Indium tin Oxide (ITO), for example, which is selectively etched to produce regions of ITO that are electrically isolated from each other. The regions where the ITO has been etched away are “isolation areas”, as shown in the center in FIG. 2 between the two portions of electrode layers 218. The adhesive layer is formed below the electrode layer 218 and between portions of the electrode layer 218 in the isolation areas.

The electrode layer 218 and any underlying substrate may be laminated to a black or grey color to give a black or grey appearance to the device when in an off state. However, the electrode layer 218 reflects substantially more light than the isolation areas, which could lead to an undesirable visible contrast between the ITO areas and the isolation areas. Embodiments of the present invention substantially eliminate this visible contrast, through the use of the reflective polarizer 210. The reflective polarizer 210 may be a DBEF (Dual Brightness Enhancement Film), such as a 3M Vikuiti DBEF. The reflective polarizer 210 passes light of a first polarization and reflects light of another polarization.

The low-E polarizer 212 is a low-efficiency polarizer. The low-E polarizer is an absorbing polarizer with a low polarization efficiency relative to that of a perfectly absorbing polarizer, where the polarization efficiency is defined as the amount of polarized light transmitted in the direction of the polarizer's maximum polarized light transmission divided by the amount of polarized light transmitted in the direction of the polarizer's minimum polarized light transmission, when an unpolarized light source is projected through the polarizer. The low-E polarizer can be used to adjust the appearance of the user interface. In particular, without the use of the low-E polarizer 212, the reflective polarizer 210 may impart a silvery or shiny appearance to the user interface. It may be desired to have a user interface that has a grey appearance, which may be imparted by including the low-E polarizer 212. The grey level may be controlled by selecting a low-E polarizer with an appropriate efficiency. Embodiments of the invention may be used with the reflective polarizer 210 without use of the low-E polarizer 212, or may be used with both the reflective polarizer 210 and the low-E polarizer 212. When both the reflective polarizer 210 and the low-E polarizer 212 are used, one can select a reflective polarizer with the appropriate amount of reflectance and select a low-E polarizer with an efficiency to impart the desired appearance.

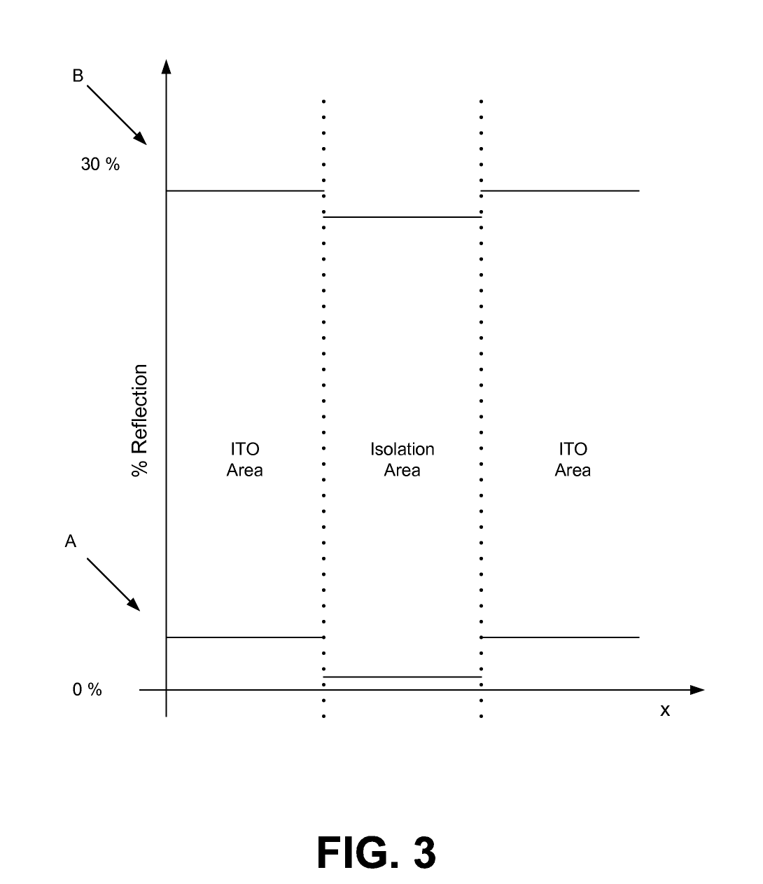

FIG. 3 is a graph illustrating the % of reflectance in the isolation areas as compared to the ITO areas in configuration A, which is the structure of FIG. 2 without the reflective polarizer 210 and the low-E polarizer 212, and configuration B, which is the structure of FIG. 2 with the reflective polarizer 210 and the low-E polarizer 212. In configuration A, the % reflectance in the ITO areas is approximately 2% reflectance, while in the isolation areas the % reflectance is approximately 0.5%. This results in a contrast between the ITO areas and the isolation areas of 2/0.5, or 4:1, which produces an undesirable visible contrast in appearance between the ITO areas and the isolation areas.

In configuration B, which is the structure of FIG. 2 with the reflective polarizer 210 and the low-E polarizer 212, the % reflectance is raised in both the isolation areas and the ITO areas by approximately 25%. This results in a % reflectance in the ITO areas of approximately 27% and in the isolation areas of approximately 25.5%, which produces a contrast of 27/25.5, 1.05:1. This results in a substantially invisible contrast between the isolation areas and the ITO areas, yielding a substantially uniform grey or black appearance.

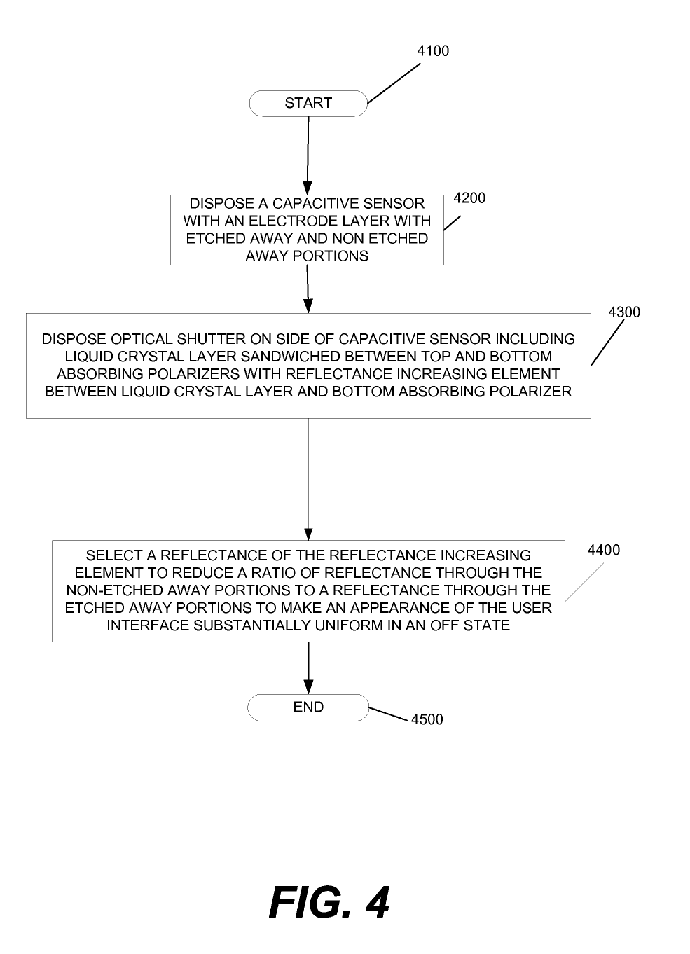

FIG. 4 illustrates an exemplary flow diagram of method of manufacturing a mobile electronic device according to embodiments of the invention. At 4100, the method starts. At 4200, a capacitive sensor is disposed having an electrode layer with non-etched away portions and etched away portions, and having isolation areas formed in the etched away portions.

At 4300, a segmented optical shutter is disposed on a side of the capacitive sensor. The optical shutter includes a liquid crystal layer sandwiched between a top absorbing polarizer and a bottom absorbing polarizer, and includes a reflectance increasing element disposed between the liquid crystal layer and the bottom absorbing polarizer.

At 4400, a reflectance of the reflectance increasing element is selected to reduce a ratio of a reflectance through the non-etched away portions to a reflectance through the etched away portions to make an appearance of the user interface substantially uniform in an off state. At 4500, the process ends.

Although the above description may contain specific details, they should not be construed as limiting the claims in any way. Other configurations of the described embodiments of the invention are part of the scope of this invention. Accordingly, the appended claims and their legal equivalents should only define the invention, rather than any specific examples given.

We claim:

1. A mobile electronic device having a user interface for receiving a touch input, comprising:
a capacitive sensor having an electrode layer with non-etched away portions and etched away portions, and having isolation areas formed in the etched away portions; and
a segmented optical shutter disposed on a side of the capacitive sensor, the optical shutter including a liquid crystal layer sandwiched between a top absorbing polarizer and a bottom absorbing polarizer, and including a reflectance increasing element disposed between the liquid crystal layer and the bottom absorbing polarizer,
wherein a reflectance of the reflectance increasing element is selected to reduce a ratio of a reflectance through the non-etched away portions to a reflectance through the etched away portions to make an appearance of the user interface substantially uniform in an off state.

2. The mobile electronic device of claim 1, wherein reflectance increasing element is a reflective polarizer.

3. The mobile electronic device of claim 2, wherein the reflective polarizer is a dual-brightness-enhancement-film (DBEF) polarizer.

4. The mobile electronic device of claim 1, further comprising a low-efficiency polarizer disposed between the liquid crystal layer and the reflectance increasing element.

5. The mobile electronic device of claim 4, wherein an efficiency of the low-efficiency polarizer is selected to impart a desired grey appearance to the user interface.

6. The mobile electronic device of claim 1, wherein the liquid crystal layer is a twisted nematic liquid crystal layer.

7. The mobile electronic device of claim 1, wherein the mobile electronic device is one of a mobile telephone, a cellular telephone, a wireless radio, a portable computer, a laptop computer, an MP3 player, and a satellite radio.

8. A method of manufacturing a mobile electronic device having a user interface for receiving a touch input, comprising:
disposing a capacitive sensor having an electrode layer with non-etched away portions and etched away portions, and having isolation areas formed in the etched away portions;
disposing a segmented optical shutter on a side of the capacitive sensor, the optical shutter including a liquid crystal layer sandwiched between a top absorbing polarizer and a bottom absorbing polarizer, and including a reflectance increasing element disposed between the liquid crystal layer and the bottom absorbing polarizer; and
selecting a reflectance of the reflectance increasing element to reduce a ratio of a reflectance through the non-etched away portions to a reflectance through the etched away portions to make an appearance of the user interface substantially uniform in an off state.

9. The method of claim 8, wherein the reflectance increasing element is a reflective polarizer.

10. The method of claim 9, wherein the reflective polarizer is a dual-brightness-enhancement-film (DBEF) polarizer.

11. The method of claim 8, further comprising disposing a low efficiency polarizer between the liquid crystal layer and the reflectance increasing element.

12. The method of claim 11, wherein an efficiency of the low-efficiency polarizer is selected to impart a desired grey appearance to the user interface.

13. The method of claim 18, wherein the liquid crystal layer is a twisted nematic liquid crystal layer.

14. The method of claim 8, wherein the mobile electronic device is one of a mobile telephone, a cellular telephone, a wireless radio, a portable computer, a laptop computer, an MP3 player, and a satellite radio.

15. An apparatus having a user interface for receiving a touch input, comprising:
a capacitive sensor having an electrode layer with non-etched away portions and etched away portions, and having isolation areas formed in the etched away portions; and
a top absorbing polarizer disposed on a side of the capacitive sensor;
a liquid crystal layer disposed on a side of the top absorbing polarizer opposite to the capacitive sensor;
a reflectance increasing element disposed on a side of the liquid crystal layer opposite to the top absorbing polarizer; and
a bottom absorbing polarizer disposed on a side of the reflectance increasing element opposite to the liquid crystal layer,
wherein a reflectance of the reflectance increasing element is selected to reduce a ratio of a reflectance through the non-etched away portions to a reflectance through the etched away portions to make an appearance of the user interface substantially uniform in an off state.

16. The apparatus of claim 15, wherein reflectance increasing element is a reflective polarizer.

17. The apparatus of claim 16, wherein the reflective polarizer is a dual-brightness-enhancement-film (DBEF) polarizer.

18. The apparatus of claim 15, further comprising a low-efficiency polarizer disposed between the liquid crystal layer and the reflectance increasing element.

19. The apparatus of claim 18, wherein an efficiency of the low-efficiency polarizer is selected to impart a desired grey appearance to the user interface.

20. The apparatus of claim 15, wherein the apparatus is one of a mobile telephone, a cellular telephone, a wireless radio, a portable computer, a laptop computer, an MP3 player, and a satellite radio.
